(19) United States
(12) Patent Application Publication
(10) Pub. No.: US 2005/0008461 A1
(43) Pub. Date: Jan. 13, 2005

(54) Convertible hay bale and flat bed trailer

(76) Inventor: Sean D. Herdrich, Dallas City, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/851,286

(22) Filed: May 21, 2004

Related U.S. Application Data
(60) Provisional application No. 60/474,167, filed on May 22, 2003.

(51) Int. Cl. B60P 1/04

(52) U.S. Cl. 414/24.5; 414/482

(57) ABSTRACT

A convertible hay bale and flat bed trailer includes a tubular steel frame having a tongue, a front support section and a generally U-shaped section; a hay bale spike pivotably mounted to the front support section of the frame and extending generally into the center of the U-shaped section; a pivoting mechanism connected with the front support section of the frame and the hay bale spike; an accessory flat bed having a mounting brace for removably engaging the hay bale spike including a plurality of collars to engage the spike; and a stabilizing link.

### CROSS-REFERENCES

This application claims the priority of provisional application Ser. No. 60/474,167, filed May 22, 2003.

### TECHNICAL FIELD OF THE INVENTION

This invention generally relates to agricultural machinery and, more particularly, to an apparatus for hauling hay bales and other items.

### DESCRIPTION OF THE RELATED ART

Various forage crops are formed into bales after being harvested. The crops are commonly baled while still in the field. Large bale-moving equipment then transports the bales for storage, sale or use. However, there are many occasions when it is not desirable to utilize large machines to transport bales, such as when bales are located in areas that will not accommodate these large machines or when only a few bales must be moved. In these instances, bales are either moved by hand or by smaller hauling equipment.

The smaller hauling equipment previously available includes hand powered items, such as hand carts or wheelbarrows, and trailers, some of which utilize some type of specific implement to secure hay bales, capable of being towed by a vehicle. Many of these trailers utilize spikes or fork lift-type attachments to lift hay bales into a position for transport. These attachments are very well suited for carrying hay bales in a secure manner and are generally preferred to general purpose trailers which are not specifically adapted to carrying hay bales.

However, while the prior art trailers adequately perform the specific task for which they are designed, they can't be used for any other function. Therefore, they possess limited usefulness and are used fairly infrequently. Because of this fact, many farmers have difficulty justifying the expense of these trailers despite their need for a reliable means of moving hay bales.

It would be advantageous to provide a device capable of engaging and moving a hay bale in a secure manner that is also suitable for uses other than hauling hay bales, thereby making it easier for a potential purchaser to justify the expense of the device.

The present invention is directed to overcoming one or more of the problems set forth above.

### SUMMARY OF THE INVENTION

An aspect of the present invention is to provide a hay bale trailer that is capable of engaging and moving a hay bale in a secure manner and can be towed by a lighter duty vehicle.

Another aspect of the present invention is to provide a hay bale trailer that is quickly convertible into a more general purpose flat bed trailer.

In accordance with the above aspect of the invention, there is provided a convertible hay bale and flat bed trailer that includes a tubular steel frame having a tongue, a front support section and a generally U-shaped section; a hay bale spike pivotably mounted to the front support section of the frame and extending generally into the center of the U-shaped section; a pivoting mechanism connected with the front support section of the frame and the hay bale spike; an accessory flat bed having a mounting brace for removably engaging the hay bale spike; and a stabilizing link.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a side view of a convertible hay bale and flat bed trailer in the hay bale mode according to one embodiment of the present invention.

FIG. 2 is a side view of the convertible trailer of FIG. 1 with its bale spike in a raised, transport position.

FIG. 3 is a perspective view of the front region of a convertible hay bale and flat bed trailer in the hay bale mode according to another embodiment of the present invention.

FIG. 4 is a schematic diagram of a flat bed being positioned on a hay bale spike of a convertible hay bale and flat bed trailer in the hay bale mode according to another embodiment.

FIG. 5 is a side view of a convertible hay bale and flat bed trailer in the flat bed mode.

FIG. 6 is a side view of the trailer of FIG. 5 with the flat bed in a lowered position.

FIG. 7 is a view of the underside of the trailer of FIG. 5.

FIG. 8 is a schematic view of a mechanical locking mechanism for a convertible hay bale and flat bed trailer according to another embodiment.

FIG. 9 is a schematic view of a latching mechanism to secure a flat bed in a convertible hay bale and flat bed trailer according to another embodiment.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

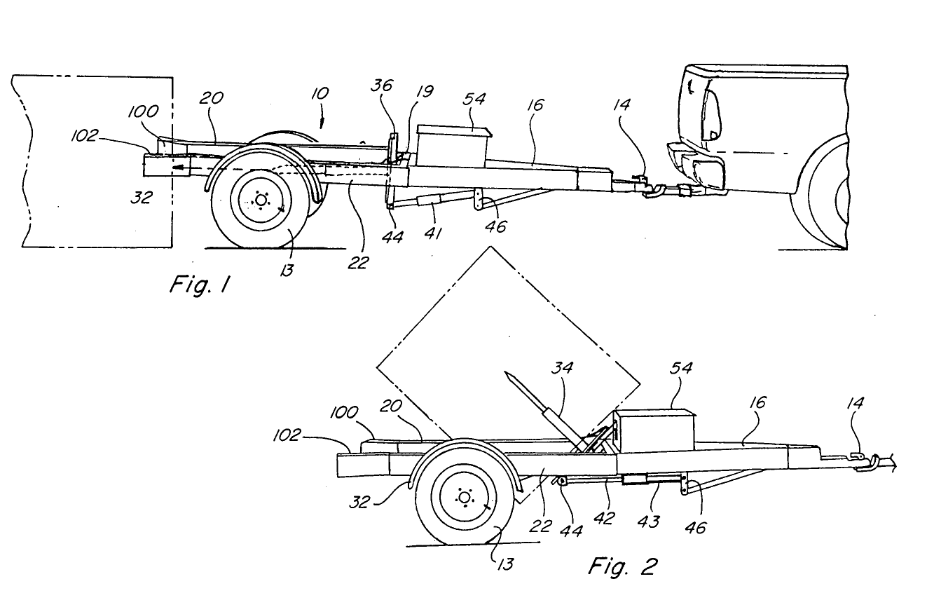

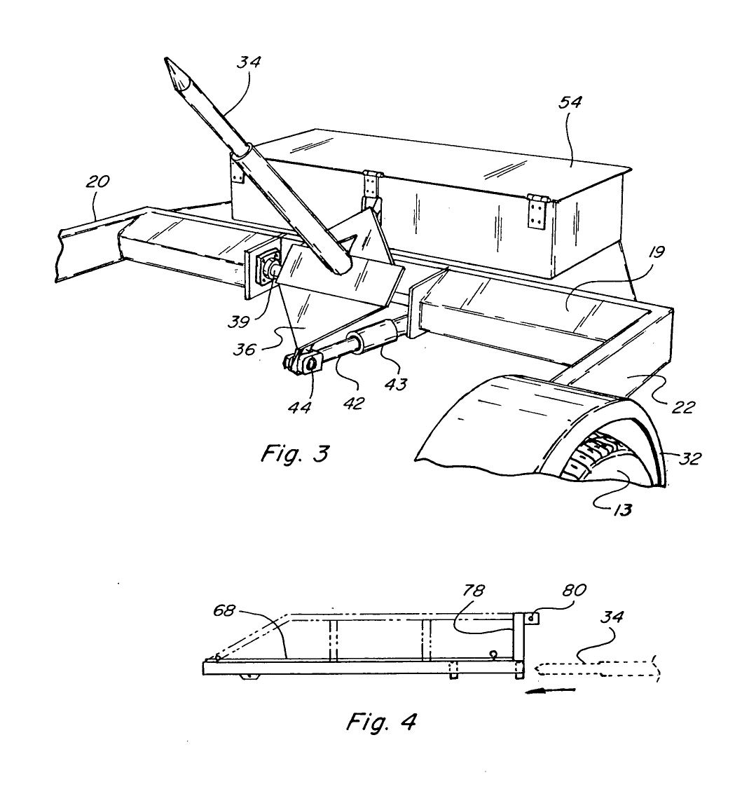

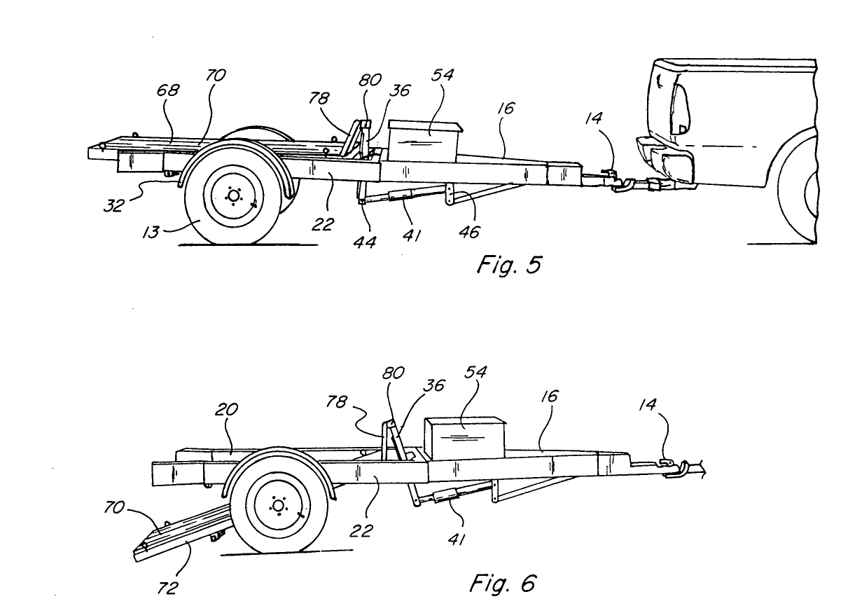

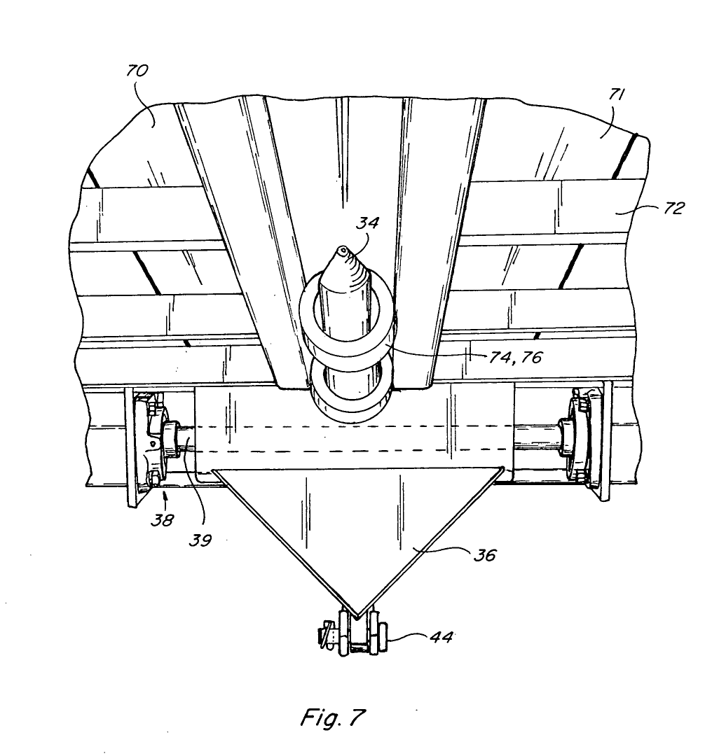

In the embodiments shown in FIGS. 1-9, a convertible hay bale trailer 8 includes a frame 10. The frame 10 is composed of a generally U-shaped section 18, a front support section 16 and a tongue 14. The tongue 14 is suitable for connection to a standard ball hitch as provided on most towing vehicles. The front support section 16 is generally triangular in shape. The U-shaped section 18 is formed by left and right frame extensions 20, 22 and a split front bar 19 that connects the front ends of the frame extensions 20, 22. The front bar 19 is supported and connected with the tongue by the front support section 16. The back ends of the extensions 20, 22 are unconnected, thereby forming an access clearance 23 that is wide enough to allow the U-shaped frame 18 to straddle a standard hay bale. In a preferred embodiment, each of the frame extensions 20, 22 is provided with an outwardly angled arm 100, 102. The angled arms 100, 102 assist the operator in aligning the trailer with and “surrounding” a hay bale. Each of the extensions 20, 22 is provided with a wheel extension 24, 26. The wheel extensions 24, 26 support axles 28, 30 and wheels 12, 13 in a known manner. The frame 10 is light enough to be towed by lighter duty vehicles, such as compact pickup trucks or sports utility vehicles.

A pivoting connection 38 for a hay bale spike 34 is located in the open space provided in the split front bar 19. The connection 38 includes a pivot bar 39 mounted between the two parts of the split front bar 19. A support plate 36 for the hay bale spike is pivotably mounted on the pivot bar 39. The support plate 36 may be of any suitable shape and composition, but preferably includes top and bottom extensions. The hay bale spike 34 is fixedly mounted approximately to the middle of the support plate 36. Alternately, the pivot bar 39 can be pivotably mounted to the two parts of the split front bar 19 and the support plate 36 fixedly mounted to the pivot bar 39.

The support plate 36 and hay bale spike 34 are pivoted relative to the frame 10 by a pivoting mechanism 40. In the embodiment shown in FIGS. 1-7, the pivoting mechanism includes a piston/cylinder assembly 41. The piston 42 and the bottom of the support plate 36 are connected via a first pivoting connection 44. The cylinder 43 and the frame are also connected with a second pivoting connection 46. In a preferred embodiment, the piston/cylinder assembly 41 is hydraulically operated. A reservoir 48 for the hydraulic cylinder assembly 41 is housed in an enclosure 54 mounted to the front support section 16 and communicates with the cylinder assembly via hoses in a known manner. The hay bale spike 34 is lowered into a generally horizontal position when the hydraulic piston 42 is retracted into the cylinder 43. This is the loading position. When the hydraulic piston 42 is extended, the support plate 36 and spike 34 are pivoted about the pivot bar 39, thereby raising the spike 34. This position secures a loaded hay bale onto the spike 34 for transport.

The hydraulic cylinder assembly is controlled by a hydraulic pump 49, which is also housed in the front enclosure 54. The hydraulic pump 49 is controlled by an electrically powered controller 50, which primarily consists of two solenoids. The solenoids are operated by any suitable control mechanism, such as buttons pull tabs, or switches. The controller 50, as well as any required trailer lights, are provided with electrical power by an auxiliary battery (not shown) located in the front enclosure 54. The auxiliary battery is connected with and recharged by the tow vehicle's battery.

Additional suitable means for pivoting the hay bale spike include a pneumatically-powered cylinder or a threaded screw and nut combination powered by an electrical motor.

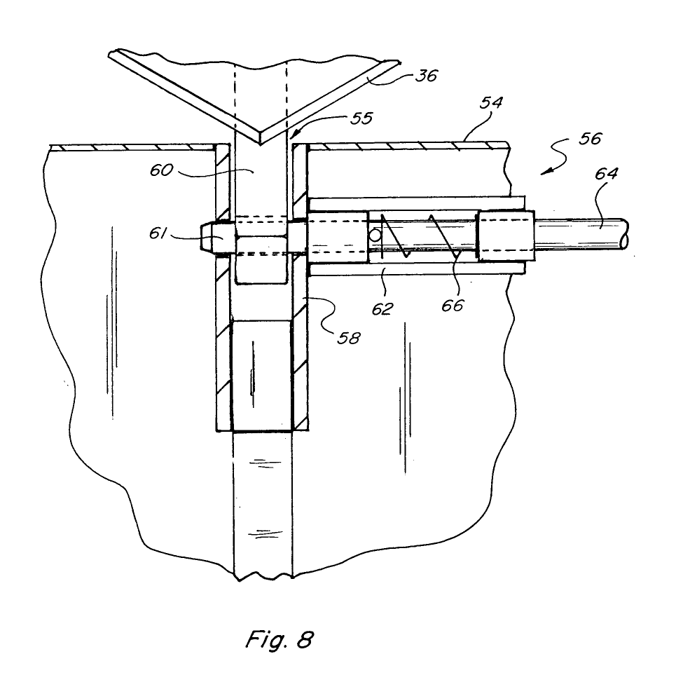

As shown in FIG. 8, the trailer is also provided with a locking mechanism 56 to secure the spike 34 in the raised, transport position. This ensures that the spike will not be unexpectedly lowered during transport due to a failure in the hydraulic system, such as a loss of hydraulic fluid. The locking mechanism consists of a locking extension 60 attached to the top of the support plate 36 and a locking collar 58 fixed to the frame within the front enclosure 54. When the spike 34 and support plate 36 are moved to the raised, transport position, the locking extension 60 is inserted into the front enclosure 54 through an opening 55 and into the locking collar 58. A locking pin 61 is then moved into position to engage both the locking collar 58 and extension 60 and secure the two relative to one another. The locking pin 61 is pulled out of the collar 58 and extension 60 in order to allow the support plate 36 and spike 34 to be lowered. A guide 62 attached to the locking collar 58 restricts the path of the locking pin 61. A handle 64 connected to the pin 61 extends through the wall of the front enclosure 54 to enable a user to engage and disengage the locking mechanism 56. In a preferred embodiment, a spring 66 surrounds the locking pin 61 within the guide 62 in order to bias the pin 61 toward engagement with the collar 58 and extension 60.

In operation, a user lowers the spike 34 into the horizontal, loading position by activating the hydraulic pump to retract the piston 42 into the cylinder 43 (first ensuring that the locking mechanism 56 is fully disengaged). The trailer is then backed toward a hay bale, thereby inserted the spike 34 into the bale. Once the spike 34 is inserted fully into the bale, the spike 34 is raised into the transport position by extending the piston 42. The use then inserts the locking pin 61 into the locking collar 58 and extension 60 to secure the load. Once the user has arrived at the delivery destination, the locking mechanism 56 is disengaged, the spike 34 is lowered, and the bale can be removed.

FIGS. 4-7 illustrate an accessory flat bed 68 that allows the trailer 8 to be readily converted from a dedicated hay bale transport to a multi-purpose flat bed trailer. The flat bed is composed of a top surface 70 and support frame 72. The support frame 72 is preferably made of welded tubular steel for structural rigidity. The top surface in the embodiment shown is formed by wooden boards 71 placed side by side. However, the top surface 70 may be formed from any suitable flat materials.

The flat bed 68 is arranged to engage and be supported by the hay bale spike. To accomplish this, the support frame 72 includes a mounting brace 74. In the embodiment shown, the mounting brace is formed by a plurality of collars 76 welded to the support frame 72. As the flat bed 68 is positioned on the trailer 8, the collars 76 surround and engage the hay bale spike 34. While two collars are shown in the illustrated embodiments, embodiments utilizing a single collar 76 are expressly contemplated as falling within the scope of the present invention. Furthermore, other shapes and forms for both the spike 34 and collar 76, for example, square, octagonal, etc., are possible and are contemplated within the scope of the invention.

While the collars 76 and spike 34 provide the primary support for the flat bed 68, additional stabilization is required. Therefore, the support frame 72 includes a front frame 78 that engages the support plate 36. The front frame 78 is a generally A-shaped tubular steel frame with an extension 80 attached to its apex. The front frame extension 80 is arranged to mate with the locking extension 60 of the support plate 36. The two extensions 60, 80 are bolted together.

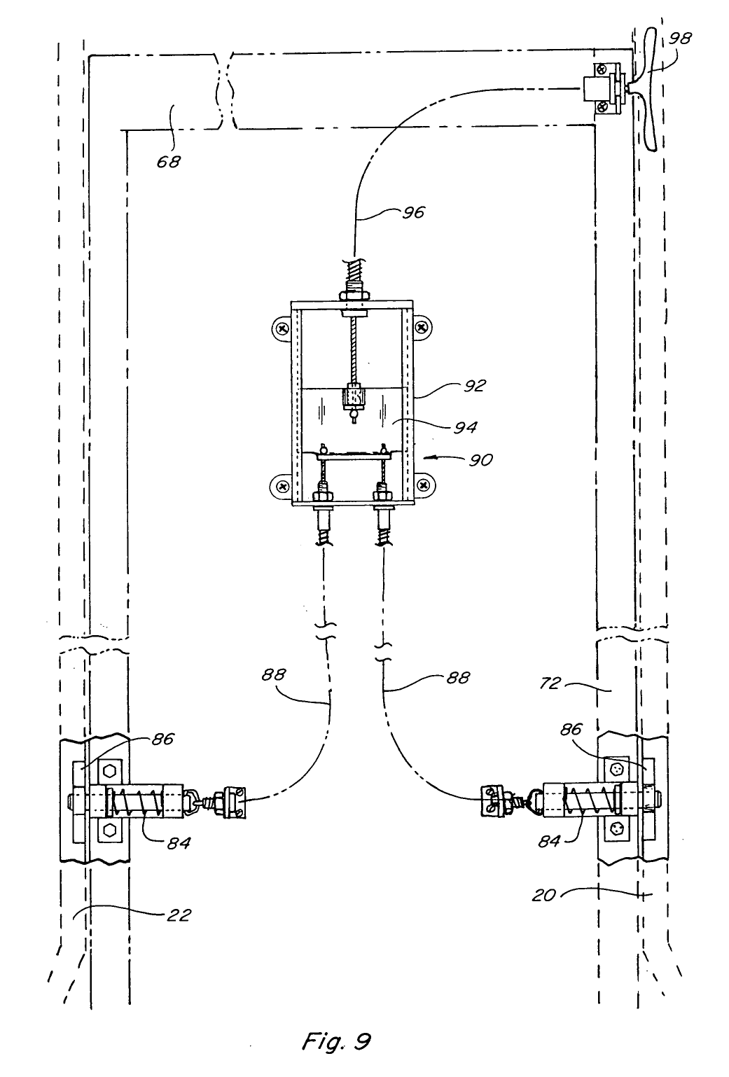

Additional stabilization for the flat bed is provided at the rear of the flat bed 68 as illustrated in FIG. 9. The additional stabilizing mechanism includes a pair of spring loaded pins 84 on either side of the support frame 72. The pins 84 are arranged to align with and engage pin receiving plates 86 mounted at the left and right extensions 20, 22 of the frame 10 when the flat bed 68 is in place on the spike 34. The pins 84 are retracted to allow the flat bed 68 to be properly positioned. Once the flat bed is positioned, the pins 84 are released and allowed to engage the plates 86. The engagement of the pins 84 with the holes 86 provides the additional stabilization required for the flat bed.

In a particularly advantageous embodiment, both spring loaded pins 84 are provided with connecting wires 88 at their ends. When the connecting wires 88 are pulled, each of the pins 84 is retracted. The connecting wires are joined at a sliding junction 90 that includes a base 92 and a slide 94. In particular, the wires 88 are connected to one side of the slide 94. A control cable 96 is connected to the other side of the slide 94 and extends to one side of the front of the flat bed 68. When the control cable 96 is pulled, the slide 94 and the connecting wires 88 are moved. This movement of the connecting wires 88 retracts the pins 84 to allow the flat bed 68 to be properly positioned prior to engagement of the pins 84 with the holes 86. This arrangement allows a user to manipulate both spring loaded pins 84 at the same time from a convenient location. In a preferred embodiment, the connecting wires 88 are Bowden cables. Bowden cables are known in the art are a type of flexible cable used to transmit mechanical force or energy by the movement of an inner cable (most commonly made of steel or other metals) relative to a hollow outer cable.

Other objects, features and advantages of the present invention will be apparent to those skilled in the art. While preferred embodiments of the present invention have been illustrated and described, this has been by way of illustration and the invention should not be limited.

1. A convertible hay bale and flat bed trailer, comprising:
a frame having a hay bale spike mounted thereto; and
an accessory flat bed having a mounting brace for engagement with said hay bale spike and at least one stabilizing link.

2. The convertible hay bale and flat bed trailer of claim 1, wherein the hay bale spike is pivotably connected with said frame and further comprising a pivoting mechanism connected with said frame and said hay bale spike.

3. The convertible hay bale and flat bed trailer of claim 2, wherein the pivoting mechanism comprises a piston and cylinder combination.

4. The convertible hay bale and flat bed trailer of claim 3, wherein the piston and cylinder combination is hydraulically operated.

5. The convertible hay bale and flat bed trailer of claim 4, further comprising:
a locking extension connected with said hay bale spike; and
a locking mechanism connected with said frame, wherein said hay bale spike is secured in a travel position relative to said frame by engaging said locking extension with said locking mechanism.

6. The convertible hay bale and flat bed trailer of claim 1, wherein the mounting brace comprises at least one collar to engage the hay bale spike.

7. The convertible hay bale and flat bed trailer of claim 1, wherein said frame further comprises a support plate and wherein said stabilizing link comprises an extension connected with said flat bed, wherein said extension is connectible with said support plate.

8. The convertible hay bale and flat bed trailer of claim 7, wherein said stabilizing link further comprises a pin slideably connected with said flat bed and a pin receiver associated with said frame.

9. The convertible hay bale and flat bed trailer of claim 1, wherein said stabilizing link comprises a first pin slideably connected with the flat bed and a first pin receiver associated with said frame.

10. The convertible hay bale and flat bed trailer of claim 9, further comprising:
a second pin slideably connected with said flat bed;
a second first pin receiver associated with said frame;
a sliding junction, said sliding junction in communication with said first and second pins;
a control cable in communication with said sliding junction, wherein when said control cable is pulled, both said first and second pins are removed from said first and second pin receivers.

11. A convertible hay bale and flat bed trailer, comprising:
a frame having a front support section and a generally U-shaped section;
a hay bale spike pivotably connected with said front support section and extending generally into said U-shaped section;
a pivoting mechanism connected with said hay bale spike and said frame; and
an accessory flat bed having a mounting brace for removably engaging said hay bale spike and a stabilizing link.

12. The convertible hay bale and flat bed trailer of claim 11, wherein said pivoting mechanism comprises a hydraulically operated piston and cylinder combination.

13. The convertible hay bale and flat bed trailer of claim 11, further comprising:
a locking extension connected with said hay bale spike; and
a locking mechanism connected with said frame, wherein said hay bale spike is secured in a travel position relative to said frame by engaging said locking extension with said locking mechanism.

14. The convertible hay bale and flat bed trailer of claim 11, wherein said mounting brace comprises at least one collar to engage said hay bale spike.

15. The convertible hay bale and flat bed trailer of claim 11, wherein said frame further comprises a support plate and wherein said stabilizing link comprises an extension connected with said flat bed, wherein said extension is connectible with said support plate.

16. The convertible hay bale and flat bed trailer of claim 11, wherein said hay bale spike comprises a support plate and wherein said stabilizing link comprises:
an extension connected with said flat, wherein said extension is connectible with said support plate; and
a first pin slideably connected with said flat bed and a first pin receiver associated with said frame.

17. The convertible hay bale and flat bed trailer of claim 16, further comprising:
a second pin slideably connected with said flat bed;
a second pin receiver associated with the frame;
a sliding junction, said sliding junction in communication with said first and second pins;
a control cable in communication with said sliding junction, wherein when said control cable is pulled, both said first and second pins are removed from said first and second pin receivers.

18. The convertible hay bale and flat bed trailer of claim 17, wherein said first and second pin receivers are associated with the rear of said U-shaped section of said frame and wherein said control cable is connected to a handle at an end opposite the control cable's connection with said sliding junction; said handle slideably mounted at the front of said flat bed.

19. A method of converting a hay bale trailer to a flat bed trailer, comprising the steps of:
providing a frame having a hay bale spike mounted to said frame;
providing an accessory flat bed having a mounting brace and at least one stabilizing link; and
installing said flat bed onto said frame by engaging said hay bale spike with said mounting brace and connecting said stabilizing link with said frame.

20. The method of converting a hay bale trailer to a flat bed trailer of claim 19, wherein:
said step of providing an accessory flat bed having a mounting brace comprises providing a collar as part of said mounting brace; and
said step of installing said flat bed onto said frame comprises inserting said hay bale spike through said collar.

21. A convertible hay bale and flat bed trailer, comprising:
a tubular steel frame having a front support section and a generally U-shaped section;
a pair of wheels supporting said frame;
a hay bale spike pivotably connected with said front support section and extending generally into the center of said U-shaped section;
a piston/cylinder combination pivotably connected with said front support section and said hay bale spike; and
an accessory flat bed having a collar for removably engaging said hay bale spike and a stabilizing link, said stabilizing link comprising:
an extension on said flat bed, wherein said extension is connectible with said frame; and
a first pin slideably connected with said flat bed and a first pin receiver associated with said frame.

22. The convertible hay bale and flat bed trailer of claim 21, wherein said pivotable connection of said hay bale spike and said front support section comprises:
first and second frame extensions connected with said front support, said first and second frame extensions defining a space therebetween;
a bar connected with said first and second frame extensions in the space between said first and second frame extensions; and
a support plate connected to said bar with said hay bale spike being connected to said support plate.
